(19) United States
(12) Patent Application Publication
(10) Pub. No.: US 2026/0311606 A1
(43) Pub. Date: Oct. 8, 2026

(54) MONITORING OF REMOTE IDENTIFICATION (RID) BROADCASTING USING ROAD-SIDE UNIT (RSU)

(71) Applicant: Telefonaktiebolaget LM Ericsson (publ), Stockholm (SE)

(72) Inventor: Fengpei ZHANG, Guangzhou (CN)

(73) Assignee: Telefonaktiebolaget LM Ericsson (publ), Stockholm (SE)

(21) Appl. No.: 19/484,429

(22) PCT Filed: May 17, 2023
(86) PCT No.: PCT/CN2023/094660

§ 371 Date: Nov. 14, 2025

(51) Int. Cl. G08G 5/57; G08G 5/55; H04W 4/06

(52) U.S. Cl. CPC G08G 5/57; G08G 5/55; H04W 4/06

(57) ABSTRACT

The present disclosure is related to methods and network nodes for monitoring RID broadcasting using RSUs. A method at a first network node for RID comprises: determining whether one or more first messages comprising RID information broadcasted by a terminal device are received from one or more second network nodes; and determining whether the terminal device is in a normal state or an abnormal state based on at least the determination of whether the one or more first messages comprising the RID information broadcasted by the terminal device are received from the one or more second network nodes.

### TECHNICAL FIELD

The present disclosure is related to the field of telecommunications, and in particular, to methods and network nodes for monitoring Remote Identification (RID) broadcasting using Road-Side Units (RSUs).

### BACKGROUND

Unmanned Aircraft or Uncrewed Aircraft (UA), also known as drone, technology has significantly evolved in the last decade, and UA manufacturers have been providing affordable solutions to consumers. Such evolution has opened the opportunity for many enterprises to consider employing UA to support their operations. For example, Business Insider forecasts that total global shipments will reach 29 million by 2021 for the consumer market and 2.4 million by 2023 for the commercial market—with an impressive 66.8% Compound Annual Growth Rate (CAGR). The growth potential of commercial UA is expected to increase, with the ability to control the UA from a control room instead of a standard Ground Control Station (GCS) connected using short-range communication. The true potential for commercial UA can only be realized by Beyond Visual Line of Sight (BVLOS, sometimes referred to simply as Beyond Line of Sight), but most of these operations cannot be conducted safely with unlicensed spectrum.

Due to the Increasing number of UA operations, regulators recognize that most UA should be electronically identifiable for safety and security reasons. The identification of UA is particularly needed to prevent unauthorized operations in restricted airspace, to address suspicious operations near sensitive facilities, and to increase airspace awareness. During the past few years, citizens and law enforcement have been concerned that UA were flying in unauthorized areas or they were infringing upon individual privacy; therefore, regulators needed a mechanism to be able to identify a UA and the pilot. In order to address those concerns, a real time ability to identify UA in the local airspace is needed at any time. In later phases, such identification can support the basic functionalities for coordination of UA flights in Unmanned Aircraft System (UAS) Traffic Management (UTM); approving flights and collision avoidance; plans ahead of each flight and avoiding conflicting flight plans allowing for modification

Identification allows governments to have a mechanism to be used as a basis for safety, security, and enforcing rule compliance. The system is analogous to that of vehicle licensing, each vehicle has an identification that is used by governments to identify the vehicle (number plate), and the driver, who is required to have an appropriate driver license, to drive the vehicle. For UA, however the environment itself presents new challenges. Primarily, the inability to check both the identification of the UA and the pilot license physically in person. Although the manned aircraft concept of “N numbers” was considered, UA are generally too small for effective physical identification. Hence the need for what is commonly called a “Remote Identification” (Remote ID or RID) and an automated system that allows authorized personnel to access information on the operation required. Remote ID should be considered the digital number plate for UA, plus the required checks and authorization to be performed. It should be noted that such Remote ID is considered as a system to support public and air traffic safety in the interest of all involved parties assuming the intention of cooperative behavior. A UA intentionally hiding from identification and detection, so not complying with rules, is not covered by Remote ID but subject to different detection systems. Remote ID provides a capability which allows for UA remote pilots to be accountable for their flying activity by removing complete anonymity, as is often the case today when UA are flying with no ID being broadcast directly from the UA and no ID being sent from the UA via a network connection. However, at the same time as accountability is increased, operational privacy is preserved for remote pilots, businesses, and their customers via procedures described in ASTM F3411-19, “Standard Specification for Remote ID and Tracking”.

### SUMMARY

There are two ways of supporting Remote ID for drones: Network Remote ID and Broadcast Remote ID. For Broadcast Remote ID, the regulators only require the drone manufactures to implement the required functions to follow the regulations and verify the functions through pre-delivery inspection.

However, since the UAS Service Supplier (USS) and/or UTM are not involved in the operation, there is not detection about a UA not broadcasting Remote ID during the flight due to malfunctioning or maliciousness.

In order to address or at least partially alleviate the above issues, some embodiments of the present disclosure provide support for monitoring RID broadcasting using RSUs.

According to a first aspect of the present disclosure, a method at a first network node for RID is provided. The method comprises: determining whether one or more first messages comprising RID information broadcasted by a terminal device are received from one or more second network nodes; and determining whether the terminal device is in a normal state or an abnormal state based on at least the determination of whether the one or more first messages comprising the RID information broadcasted by the terminal device are received from the one or more second network nodes.

In some embodiments, the step of determining whether the terminal device is in a normal state or an abnormal state comprises at least one of: determining that the terminal device is in a normal state for a first time period in response to determining that at least one first message comprising the RID information broadcasted by the terminal device is received from at least one of the second network nodes during the first time period; and determining that the terminal device is in an abnormal state for a first time period in response to determining that no first message comprising the RID information broadcasted by the terminal device is received from the one or more second network nodes during the first time period.

In some embodiments, the RID information indicates at least one of: an identifier associated with the terminal device; an identifier associated with an operator that is operating the terminal device; a location of the terminal device; an altitude of the terminal device; a heading of the terminal device; a speed of the terminal device; and a status of the terminal device. In some embodiments, the first message further indicates an identifier of the second network node.

In some embodiments, the terminal device is an unmanned aircraft, wherein before the step of determining whether one or more first messages comprising RID information broadcasted by a terminal device are received from one or more second network nodes, the method further comprises at least one of: determining whether the terminal device has taken off or not; and determining whether the terminal device has landed or not. In some embodiments, before the step of determining whether the terminal device has taken off or not and/or the step of determining whether the terminal device has landed or not, the method further comprises: transmitting, to a third network node, a second message for subscribing periodical notifications of location information for the terminal device; and receiving, from the third network node, a third message indicating an identifier associated with a first subscription of the periodical notifications of location information for the terminal device.

In some embodiments, the method further comprises: periodically receiving, from the third network node, fourth messages for notifying the first network node of the location information for the terminal device; and transmitting, to the third network node, fifth messages in response to the fourth messages, respectively. In some embodiments, the method further comprises at least one of: determining the velocity of the terminal device based on at least locations of the terminal device indicated by the location information in multiple fourth messages; and determining the velocity of the terminal device based on at least a velocity of the terminal device indicated by the location information in one or more fourth messages.

In some embodiments, the method further comprises: determining whether the velocity of the terminal device is higher than a first threshold for a second time period or not, wherein the step of determining whether the terminal device has taken off or not comprises at least one of: determining that the terminal device has taken off in response to determining that the velocity of the terminal device is higher than the first threshold for the second time period; and determining that the terminal device has not taken off in response to determining that the velocity of the terminal device is not higher than the first threshold for the second time period. In some embodiments, the method further comprises: determining whether the velocity of the terminal device is lower than a second threshold for a third time period or not, wherein the step of determining whether the terminal device has landed or not comprises at least one of: determining that the terminal device has landed in response to determining that the velocity of the terminal device is lower than the second threshold for the third time period; and determining that the terminal device has not landed in response to determining that the velocity of the terminal device is not lower than the second threshold for the third time period.

In some embodiments, the second message indicates at least one of: an identifier of the terminal device; an indicator indicating that a notification of location information is to be subscribed; and an indicator indicating a callback endpoint to receive the periodical notifications. In some embodiments, at least one of the fourth messages indicates at least one of: the identifier associated with the first subscription; and the location information for the terminal device. In some embodiments, the method further comprises at least one of: determining whether the terminal device is powered on; and determining whether the terminal device is powered off. In some embodiments, before the step of determining whether the terminal device is powered on and/or the step of determining whether the terminal device is powered off, the method further comprises: transmitting, to the third network node, a sixth message for subscribing a notification of a network connectivity status for the terminal device; and receiving, from the third network node, a seventh message indicating a identifier association with a second subscription of the notification of the network connectivity status for the terminal device. In some embodiments, the method further comprises: receiving, from the third network node, an eighth message for notifying the first network node of the network connectivity status for the terminal device; and transmitting, to the third network node, a ninth message in response to the eighth message.

In some embodiments, the method further comprises at least one of: determining that the terminal device is powered on in response to receiving an eighth message indicating that a network connection is created for the terminal device; and determining that the terminal device is powered off in response to receiving an eighth message indicating that a network connection is released for the terminal device. In some embodiments, the sixth message indicates at least one of: an identifier of the terminal device; an indicator indicating that a notification of a network connectivity status is to be subscribed; and an indicator indicating a callback endpoint to receive the notification. In some embodiments, the eighth message indicates at least one of: the identifier associated with the second subscription; and information for a network connectivity status for a network connection associated with the terminal device.

In some embodiments, the method further comprises: transmitting, to the third network node, a tenth message for unsubscribing the periodical notifications of the location information for the terminal device; and receiving, from the third network node, an eleventh message in response to the ninth message. In some embodiments, when multiple first messages are received from multiple second network nodes, respectively, the method further comprises: determining whether the RID information comprised in the multiple first messages are same to each other; and determining whether a location of the terminal device indicated by the multiple first messages is in an overlapped area of the listening areas of the multiple second network nodes in response to determining that the RID information comprised in the multiple first messages are same to each other. In some embodiments, the method further comprises at least one of: determining that the location of the terminal device indicated by the multiple first messages is trusted in response to determining that the location of the terminal device indicated by the multiple first messages is in the overlapped area; and determining that the location of the terminal device indicated by the multiple first messages is untrusted in response to determining that the location of the terminal device indicated by the multiple first messages is separated from the overlapped area by an offset distance. In some embodiments, for at least one of the multiple second network nodes, its identifier and/or listening area are preconfigured or configured at the first network node.

In some embodiments, the method further comprises: storing the RID information. In some embodiments, the method further comprises: receiving, from a fourth node, a twelfth message for requesting the RID information for the terminal device; and transmitting, to the fourth node, a thirteenth message indicating the stored RID information for the terminal device. In some embodiments, at least one of following is true: the terminal device is an Unmanned Aircraft (UA); the first network node is an Unmanned Aircraft System (UAS) Service Supplier (USS) node and/or a UAS Traffic Management (UTM) node; the one or more second network nodes are Road Side Units (RSUs); the third network node is a Network Exposure Function (NEF) and/or a Service Capability Exposure Function (SCEF); and the fourth node is an observer's device. In some embodiments, the RID information is broadcasted by the terminal device via Sidelink (SL) communication.

According to a second aspect of the present disclosure, a first network node for RID is provided. The first network node comprises: a processor; a memory storing instructions which, when executed by the processor, cause the first network node to: determine whether one or more first messages comprising RID information broadcasted by a terminal device are received from one or more second network nodes; and determine whether the terminal device is in a normal state or an abnormal state based on at least the determination of whether the one or more first messages comprising the RID information broadcasted by the terminal device are received from the one or more second network nodes. In some embodiments, the instructions, when executed by the processor, further cause the first network node to perform any of the methods of the first aspect.

According to a third aspect of the present disclosure, a first network node for RID is provided. The first network node is adapted to: determine whether one or more first messages comprising RID information broadcasted by a terminal device are received from one or more second network nodes; and determine whether the terminal device is in a normal state or an abnormal state based on at least the determination of whether the one or more first messages comprising the RID information broadcasted by the terminal device are received from the one or more second network nodes. In some embodiments, the first network node is further adapted to perform any of the methods of the first aspect.

According to a fourth aspect of the present disclosure, a first network node for RID is provided. The first network node comprises: a first determining module configured to determine whether one or more first messages comprising RID information broadcasted by a terminal device are received from one or more second network nodes; and a second determining module configured to determine whether the terminal device is in a normal state or an abnormal state based on at least the determination of whether the one or more first messages comprising the RID information broadcasted by the terminal device are received from the one or more second network nodes. In some embodiments, the first network node may comprise one or more further modules, each of which may perform any of the steps of any of the methods of the first aspect.

According to a fifth aspect of the present disclosure, a method at a second network node for facilitating a terminal device in RID is provided. The method comprises: receiving, from the terminal device, an RID message comprising RID information broadcasted by the terminal device; determining a first network node to which the RID information is to be forwarded; and transmitting, to the first network node, a first message comprising the RID information.

In some embodiments, the RID information indicates at least one of: an identifier associated with the terminal device; an identifier associated with an operator that is operating the terminal device; a location of the terminal device; an altitude of the terminal device; a heading of the terminal device; a speed of the terminal device; and a status of the terminal device. In some embodiments, the step of determining the first network node comprises: determining the first network node based on at least an identifier associated with an operator that is operating the terminal device and/or one or more local configurations. In some embodiments, the first message further indicates an identifier of the second network node.

In some embodiments, at least one of following is true: the terminal device is a UA; the first network node is a USS node and/or a UTM node; and the second network node is an RSU. In some embodiments, the RID information is broadcasted by the terminal device via SL communication.

According to a sixth aspect of the present disclosure, a second network node for facilitating a terminal device in RID is provided. The second network node comprises: a processor; a memory storing instructions which, when executed by the processor, cause the second network node to: receive, from the terminal device, an RID message comprising RID information broadcasted by the terminal device; determine a first network node to which the RID information is to be forwarded; and transmit, to the first network node, a first message comprising the RID information. In some embodiments, the instructions, when executed by the processor, further cause the second network node to perform any of the methods of the fifth aspect.

According to a seventh aspect of the present disclosure, a second network node for facilitating a terminal device in RID is provided. The second network node is adapted to: receive, from the terminal device, an RID message comprising RID information broadcasted by the terminal device; determine a first network node to which the RID information is to be forwarded; and transmit, to the first network node, a first message comprising the RID information. In some embodiments, the second network node is further adapted to perform any of the method of the fifth aspect.

According to an eighth aspect of the present disclosure, a second network node for facilitating a terminal device in RID is provided. The second network node comprises: a receiving module configured to receive, from the terminal device, an RID message comprising RID information broadcasted by the terminal device; a determining module configured to determine a first network node to which the RID information is to be forwarded; and a transmitting module configured to transmit, to the first network node, a first message comprising the RID information. In some embodiments, the second network node may comprise one or more further modules, each of which may perform any of the steps of any of the methods of the first aspect.

According to a ninth aspect of the present disclosure, a tangible, non-transient computer-readable medium comprising instructions is provided. The instructions, when executed by at least one processor, cause the at least one processor to perform any of the methods of the first and/or fifth aspects.

According to a tenth aspect of the present disclosure, a computer program comprising instructions is provided. The instructions, when executed by at least one processor, cause the at least one processor to carry out any of the methods of the first and/or fifth aspects.

According to an eleventh aspect of the present disclosure, a carrier containing the computer program of the tenth aspect is provided. In some embodiments, the carrier is one of an electronic signal, optical signal, radio signal, or computer readable storage medium.

According to a twelfth aspect of the present disclosure, a computer-readable medium comprising instructions is provided. The instructions, when executed on at least one processor, cause the at least one processor to carry out any of the methods according to the first and/or fifth aspects.

According to a thirteenth aspect of the present disclosure, a system for RID is provided. The system comprises: a first network node; and one or more second network nodes, wherein at least one of the second network nodes comprises: a processor; a memory storing instructions which, when executed by the processor, cause the second network node to: receive, from a terminal device, an RID message comprising RID information broadcasted by the terminal device; determine the first network node to which the RID information is to be forwarded; and transmit, to the first network node, a first message comprising the RID information, wherein the first network node comprises: a processor; a memory storing instructions which, when executed by the processor, cause the first network node to: determine whether one or more first messages comprising RID information broadcasted by the terminal device are received from the one or more second network nodes; and determine whether the terminal device is in a normal state or an abnormal state based on at least the determination of whether the one or more first messages comprising the RID information broadcasted by the terminal device are received from the one or more second network nodes.

In some embodiments, the instructions stored in the memory of the first network node, when executed by the processor of the first network node, further cause the first network node to perform any of the methods of the first aspect. In some embodiments, the instructions stored in the memory of the second network node, when executed by the processor of the second network node, further cause the second network node to perform any of the methods of the fifth aspect.

With some embodiments of the present disclosure, the network (e.g., USS/UTM) may monitor whether or not a drone broadcasts RID message during the flight. Further, with some embodiments of the present disclosure, the network (e.g., USS/UTM) may validate the drone claimed locations by the information of receiving RSUs. Furthermore, with some embodiments of the present disclosure, observers are enabled to query drone information through Internet connection (i.e., Broadcast Remote ID and Network Remote ID are converged).

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating exemplary methods for RID with which monitoring of RID broadcasting using RSUs is applicable according to an embodiment of the present disclosure.

FIG. 2 is a diagram illustrating an exemplary Cellular-Vehicle-to-Everything (C-V2X) telecommunications system in which monitoring of RID broadcasting using RSUs is applicable according to an embodiment of the present disclosure.

FIG. 3 is a diagram illustrating an exemplary telecommunications system in which RID broadcasting may be monitored using RSUs according to an embodiment of the present disclosure.

FIG. 4 is a diagram illustrating an exemplary procedure for monitoring UA takeoff according to an embodiment of the present disclosure.

FIG. 5 is a diagram illustrating an exemplary procedure for monitoring UA landing according to an embodiment of the present disclosure.

FIG. 6 is a diagram illustrating an exemplary procedure for monitoring RID broadcasting using RSUs according to an embodiment of the present disclosure.

FIG. 7A and FIG. 7B are diagrams illustrating exemplary methods for determining whether a reported location is trusted or not according to an embodiment of the present disclosure.

FIG. 8 is a flow chart illustrating an exemplary method at a first network node for RID according to an embodiment of the present disclosure.

FIG. 9 is a flow chart illustrating an exemplary method at a second network node for facilitating a terminal device in RID according to an embodiment of the present disclosure.

FIG. 10 schematically shows an embodiment of an arrangement which may be used in network nodes according to an embodiment of the present disclosure.

FIG. 11 is a block diagram illustrating an exemplary first network node according to an embodiment of the present disclosure.

FIG. 12 is a block diagram illustrating an exemplary second network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as monitoring of RID broadcasting using RSUs are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “UE” used herein may refer to a terminal device, a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, a network node, or any other equivalents.

Further, following references are incorporated herein by reference in their entireties:
Internet Engineering Task Force (IETF), draft-ietf-drip-arch-29, (2022 Aug. 16), “Drone Remote Identification Protocol (DRIP) Architecture”;
IETF, Request For Comment (RFC) 9153, (2022-02), “Drone Remote Identification Protocol (DRIP) Requirements and Terminology”; and
Global System for Mobile Communications (GSM) Association (GSMA), “Unmanned Aircraft Remote Identification through Cellular Networks”, V0.13.

As mentioned earlier, there are two ways of supporting Remote ID for drones: Network Remote ID and Broadcast Remote ID.

### Network Remote ID

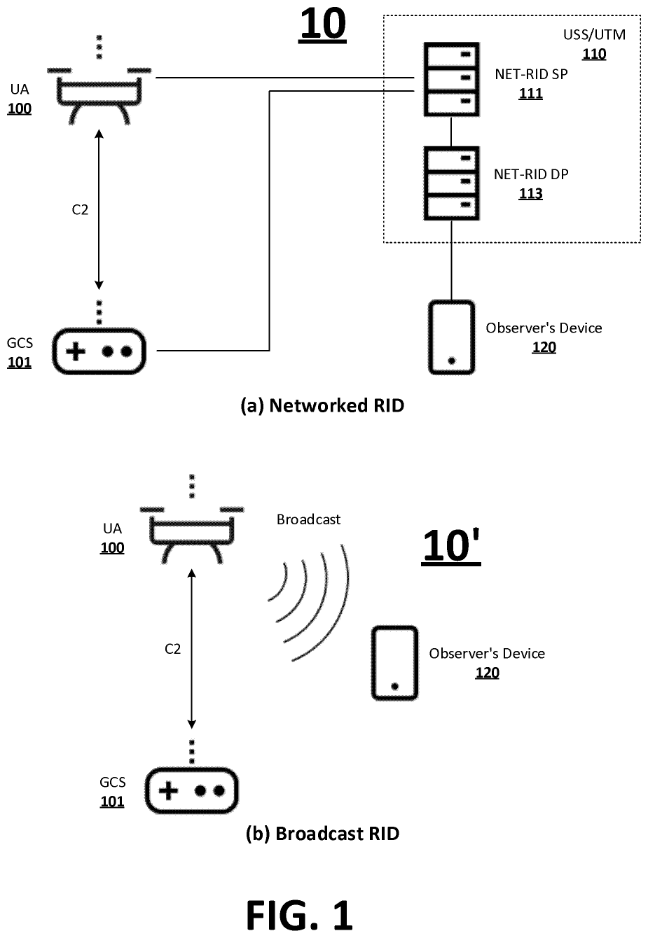

An exemplary scenario for network remote ID is shown in (a) of FIG. 1. As shown in FIG. 1, the information to be reported via UAS RID is generated by the UAS, which for example includes a UA 100 and a GCS 101. Typically, some of this data is generated by the UA 100 and some by the GCS 101, e.g., their respective Global Navigation Satellite System (GNSS) derived locations.

In some embodiments, the information is sent by the UAS (UA 100 or GCS 101) via unspecified means to the cognizant Network Remote Identification Service Provider (Net-RID SP) 111, typically the USS 110 under which the UAS is operating if participating in UTM 110.

In some embodiments, the Net-RID SP 111 publishes via the Discovery and Synchronization Service (DSS) over the Internet that it has operations in various 4-D airspace volumes (see Section 2.2 of RFC 9153), describing the volumes but not the operations.

In some embodiments, an Observer's device 120, which is expected, but not specified, to be web-based, queries a Network Remote Identification Display Provider (Net-RID DP) 113, typically also a USS, about any operations in a specific 4-D airspace volume.

In some embodiments, using fully specified web-based methods over the Internet, the Net-RID DP 113 queries all Net-RID SPs 111 that have operations in volumes intersecting that of the Observer's 120 query for details on all such operations.

In some embodiments, the Net-RID DP 113 aggregates information received from all such Net-RID SPs 111 and responds to the Observer's 120 query.

In some embodiments, Command and Control (C2) must flow from the GCS 101 to the UA 100 via some path. Currently this is typically a direct RF link. However, with increasing Beyond Visual Line of Sight (BVLOS) operations, it is expected often to be a wireless link at either end with the Internet between.

In some embodiments, telemetry (at least the UA's 100 position and heading) flows from the UA 100 to the GCS 101 via some path, typically the reverse of the C2 path. Thus, UAS RID information pertaining to both the GCS 101 and the UA 100 can be sent, by whichever has Internet connectivity, to the Net-RID SP 111, typically the USS 110 managing the UAS operation.

In some embodiments, the Net-RID SP 111 forwards UAS RID information via the Internet to subscribed Net-RID DPs 113, typically USSs 110. Subscribed Net-RID DPs 113 then forward RID information via the Internet to subscribed Observer devices 120.

### Broadcast Remote ID

An exemplary scenario for broadcast remote ID is shown in (b) of FIG. 1. As shown in FIG. 1, the UA 100 periodically broadcasts UAS RID information and Observer devices 120 nearby can receive the drone information.

V2X is a technology that allows vehicles to communicate with any entity that may affect the vehicle, and vice versa. V2X consists of more specific types of communication as V2I (Vehicle-to-Infrastructure), V2N (Vehicle-to-Network), V2V (Vehicle-to-Vehicle), V2P (Vehicle-to-Pedestrian) etc.

C-V2X allows the C-V2X device to use the cellular network connection in the traditional manner over Uu (also known as the user plane) interface. Uu refers to the logical interface between the UE and the base station. This is generally referred to V2N.

However, due to the huge amount of message exchange especially for V2V communication, 3^{rd} Generation Partnership Project (3GPP) also introduces PC5 interface (also known as “sidelink” in 3GPP Radio Access Network (RAN) specification) to support direct communication between C-V2X devices to improve the C-V2X efficiency.

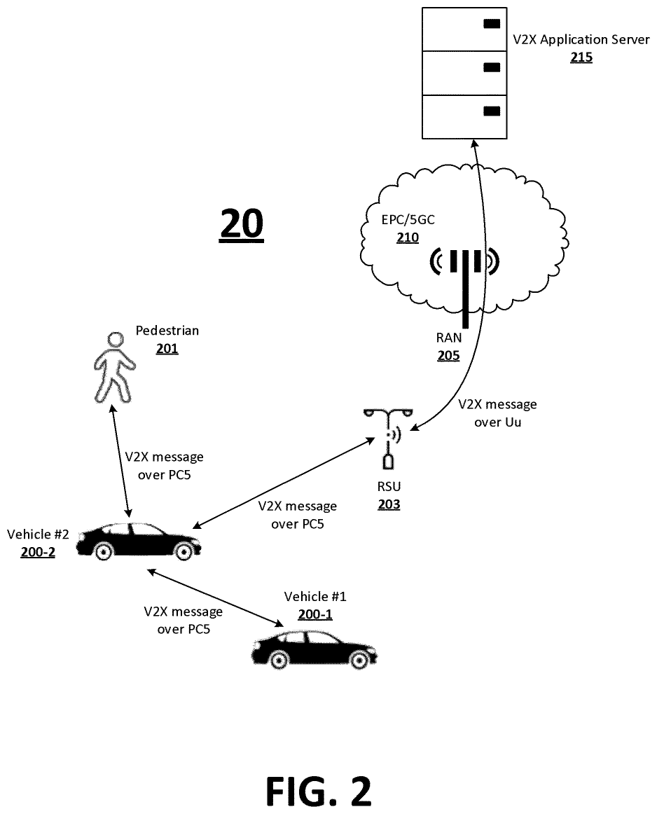

FIG. 2 is a diagram illustrating an exemplary C-V2X telecommunications system 20 in which monitoring of RID broadcasting using RSUs is applicable according to an embodiment of the present disclosure.

As shown in FIG. 2, the system 20 may comprise at least one of: one or more vehicles 200-1 and 200-2 (collectively, the vehicles 200), a pedestrian (and a UE attached to or carried by the pedestrian) 201, a Road Side Unit (RSU) 203, a RAN 205, a core network (e.g., an Evolved Packet Core (EPC) or a 5G Core (5GC)) 210, and a V2X application server 215. Please note that the present disclosure is not limited thereto. In some other embodiments, different numbers and/or different types of the entities may be present in the system 20. For example, the system 20 may comprise one or more of drones, lane markings, road signs, and traffic lights, or the like. Further, the term “UE” used herein may also refer to any of a vehicle, a pedestrian (or a device associated therewith), and an RSU shown in FIG. 2, or any other similar entity.

As shown in FIG. 2, a vehicle (e.g., the vehicle 200-2) may communicate with another vehicle (e.g., the vehicle 200-1) via V2V over the PC5 interface or reference point. As also shown in FIG. 2, a vehicle (e.g., the vehicle 200-2) may communicate with a pedestrian (e.g., the pedestrian 201) via V2P over the PC5 interface or reference point. As further shown in FIG. 2, a vehicle (e.g., the vehicle 200-2) may communicate with an RSU (e.g., the RSU 202) via V2I over the PC5 interface or reference point. As also shown in FIG. 2, an RSU (e.g., the RSU 202) may communicate with a RAN (e.g., the RAN 205) via V2N over the Uu interface or reference point. Further, other entities may communicate with each other in similar manners as described above. In other words, the UEs (e.g., the vehicles 200, the pedestrian 201, and/or the RSU 202) shown in FIG. 2 may communicate with each other via V2X over the PC5/Uu interface. In this way, a UE (e.g., the vehicle #1 200-1) in the system 20 may communicate with the V2X application server 215, for example, via the vehicle #2 200-2, the RSU 203, the RAN 205, and the EPC/5GC 210, and information, such as, vehicle information (e.g., speed, location, vehicle type, etc.), navigation information, traffic information, control commands, entertainment information, can be exchanged therebetween.

Several organizations (e.g., GSMA) advocate using mobile cellular network for drone Remote ID due to some advantages such as scalability, reliability, and availability. Specifically for broadcasting Remote ID, it may leverage 3GPP PC5/sidelink interface to broadcast the messages.

For broadcasting Remote ID, the regulators only require the drone manufactures to implement the required functions to follow the regulations and verify the functions through pre-delivery inspection. However, since the USS/UTM is not involved in the operation, there is not detection about a UA not broadcasting Remote ID during the flight due to malfunctioning or maliciousness.

Therefore, some embodiments of the present disclosure introduce the interoperation between drones and the V2X infrastructure, i.e., the Road-Side Units (RSUs). Leveraging this interoperation, USS/UTM can monitor whether the drone broadcasts RID message during the flight.

In some embodiments, given the drones using 3GPP PC5 interface to broadcast Remote ID messages, the RSUs can receive the messages and relay them to corresponding USS/UTM.

In some embodiments, after receiving the broadcast RID messages, USS/UTM can:
Monitor if the drone broadcasts RID message during the flight;
Validate the drone claimed locations by the information of receiving RSUs,
Support Observers to query drone information through Internet connection (i.e., converge Broadcast Remote ID and Network Remote ID).

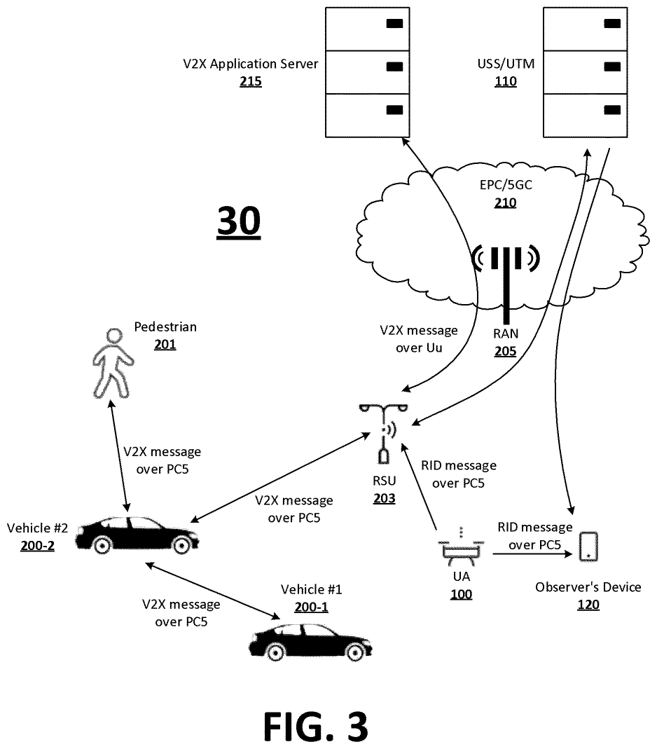

FIG. 3 is a diagram illustrating an exemplary telecommunications system 30 in which RID broadcasting may be monitored using RSUs according to an embodiment of the present disclosure. Similar to the system 20 shown in FIG. 2, the system 30 may comprise one or more RSUs 203, a RAN 205, an EPC/5GC 210, and one or more servers, such as a V2X application server 215 and/or a USS/UTM server 110.

Further, as shown in FIG. 3, the system 30 may comprise one or more terminal devices, such as vehicles 200-1, 200-2, a UE attached to or carried by the pedestrian 201, one or more drones 100, and/or one or more observer devices 120. These terminal devices may access the EPC/5GC 210 and the servers via one or more interfaces, such as, PC5 and/or Uu as shown in FIG. 3. For example, the UA 100 may broadcast its RID messages via the PC5 interface, and the RSU 203 may receive the broadcasted RID messages and forward them to the USS 110 via the Uu interface between the RSU 203 and the RAN 205. For another example, the RID messages broadcasted by the UA 100 can be received directly by the observer device 120 via the PC5 interface.

In other words, given the drones (e.g., the UA 100 shown in FIG. 3) using 3GPP PC5 interface to broadcast Remote ID messages, the drones can interoperate with the V2X infrastructure, especially the RSUs (e.g., the RSUs 203 shown in FIG. 3).

In some embodiments, the RSUs 203 may forward the received Remote ID messages to the USS 110. By collecting the Remote ID messages, the USS/UTM 110 may detect whether or not a UA 100 broadcasts Remote ID messages during the flight.

In some embodiments, observer's devices 120 may either receive drone information through PC5 interfaces or from USS/UTM through internet connectivity. Leveraging PC5 interface and RSUs 203, Broadcast Remote ID and Networked Remote ID can be converged without requiring additional functions from drones or GCSs.

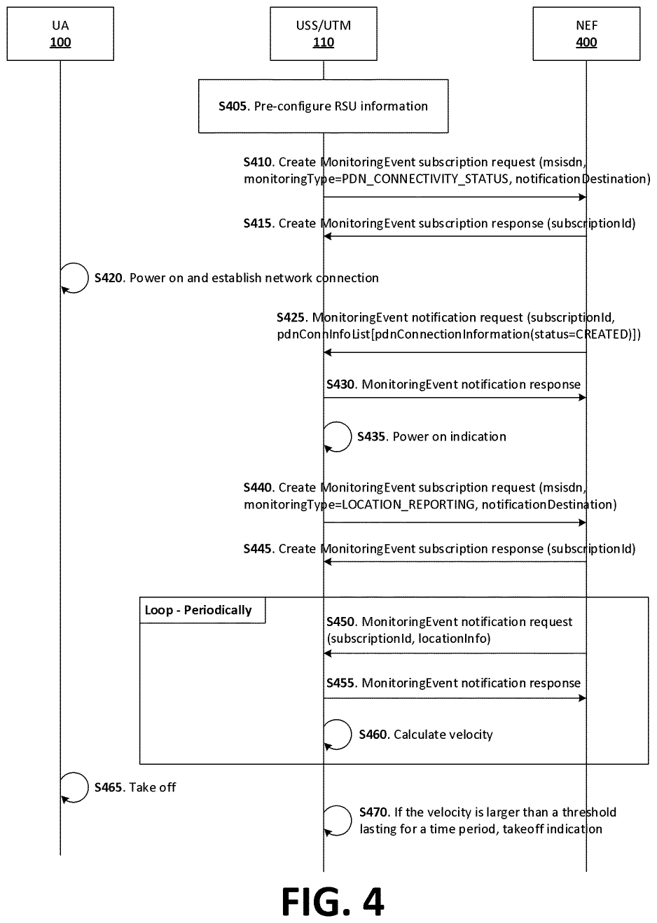

Next, some exemplary procedures that can be used with the system 30 will be described below in detail with reference to FIG. 4 through FIG. 7.

FIG. 4 is a diagram illustrating an exemplary procedure for monitoring UA takeoff according to an embodiment of the present disclosure. As shown in FIG. 4, a USS/UTM (e.g., the USS/UTM 110 shown in FIG. 3) may monitor whether a UA (e.g., the UA 100 shown in FIG. 3) has taken off or not by means of a Network Exposure Function (NEF) 400, which is a network function provided by a core network (e.g., the EPC/5GC 210 shown in FIG. 3).

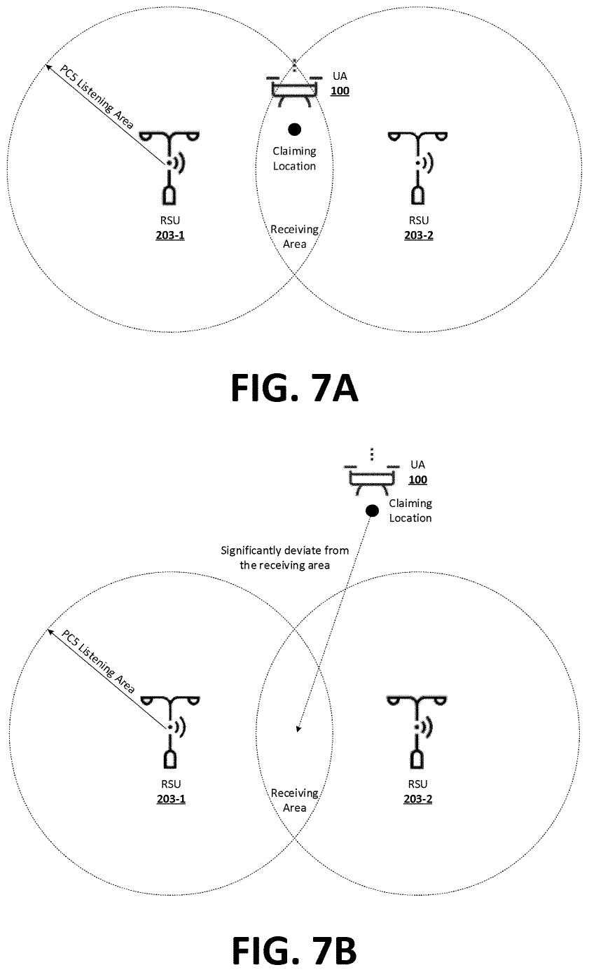

Referring to FIG. 4, the procedure may begin at step S405 where the USS/UTM 110 may be pre-configured or configured with RSU information. In some embodiments, the RSU information may at least include RSU ID and RSU location for each RSU. For example, the RSU information may indicate at least a PC5 listening area for each RSU, such that the USS/UTM 110 may estimate a location of a UA (e.g., the UE 100) when a broadcasted RID message from the UA is received via the RSU, which will be described below with reference to FIG. 7A and FIG. 7B.

At step S410, the USS/UTM 110 may send a “Create MonitoringEvent Subscription” request towards the NEF 400 to monitor the Packet Data Network (PDN) connectivity status of the UA 100. In some embodiments, the request may contain at least one of:
Mobile Station International Subscriber Directory Number (MSISDN) of the target UA 100;
monitoringType set to “PDN_CONNECTIVITY_STATUS”; and
notificationDestination, indicating the callback endpoint to receive notifications.

However, the present disclosure is not limited thereto. In some other embodiments, the request may contain different information for same purpose. For example, the target UA 100 may be identified by an International Mobile Equipment Identity (IMEI), an International Mobile subscriber Identity (IMSI), or any other identifier. For another example, a notification of an event different from “PDN_CONNECTIVITY_STATUS” can be subscribed. For example, the UA 100 may report its power on event to the core network once it is powered on, and the USS/UTM 110 may subscribe a notification of the event from the NEF 400.

At step S415, the NEF 400 may send a “Create MonitoringEvent Subscription” response back to the USS/UTM 110 with a subscriptionId.

At step S420, the UA 100 may be powered on and establish a network connection. In this case, the core network to which the UA 100 is connected may generate an event towards the NEF 400 since the NEF 400.

At step S425, the NEF 400 may send a “MonitoringEventNotification” request to the USS/UTM 110. In this way, the USS/UTM 110 may be aware of the power on event for the UA 100. In some embodiments, the request may contain at least one of:
the subscriptionId, and,
pdnConnInfoList that includes the information of one or more PDN connections, where the information of the target PDN connection contains a “status” attribute set to “CREATED”.

However, the present disclosure is not limited thereto. In some other embodiments, the notification may contain different information for the same purpose.

At step S430, the USS/UTM 110 may send a “MonitoringEvent Notification” response back to the NEF 400.

At step S435, the USS/UTM 110 may detect that the UA 100 is power-on. After that, the USS/UTM 110 may further detect whether the UA 100 has taken off or not.

However, the present disclosure is not limited thereto. In some embodiments, the detection of whether the UA 100 has taken off or not does not depend on the detection of whether the UA 100 has been powered on or not. In other words, the steps S410 through S435 may be omitted.

At step S440, the USS/UTM 110 may send another “Create MonitoringEvent Subscription” request towards the NEF 400 to monitor the network locations of the UA 100. In some embodiments, the request may contain at least one of:
MSISDN of the target UA 100;
monitoringType set to “LOCATION_REPORTING”; and
notificationDestination, indicating the callback endpoint to receive notifications.

In some embodiments, the subscription of location notification may be a subscription of periodical notifications. In some embodiments, the subscription of location notification may be a subscription of a one-time notification.

However, the present disclosure is not limited thereto. In some other embodiments, the request may contain different information for the same purpose.

At step S445, the NEF 400 may send a “Create MonitoringEvent Subscription” response back to the USS/UTM 110 with a subscriptionId.

At step S450, the NEF 400 may periodically send a “MonitoringEventNotification” request to the USS/UTM 110. In some embodiments, the request may contain at least one of:
the subscriptionId, and
locationInfo indicating the network location of the UA 100.

However, the present disclosure is not limited thereto. In some other embodiments, the notification may contain different information for the same purpose.

At step S455, the USS/UTM 110 may send a “MonitoringEvent Notification” response back to the NEF 400.

At step S460, the USS/UTM 110 may calculate the velocity of the UA 100 based on the network location, or directly use the ueVelocity attribute inside the locationInfo if available.

At step S465, the UA 100 may take off.

At Step S470, if the velocity of the UA 100 is higher than a pre-defined threshold and last for a time period, the USS/UTM 110 may detect that the UA 100 has taken off.

Therefore, with this procedure, the USS/UTM 110 may detect whether the UA 100 has been powered on and/or whether the UA 100 has taken off.

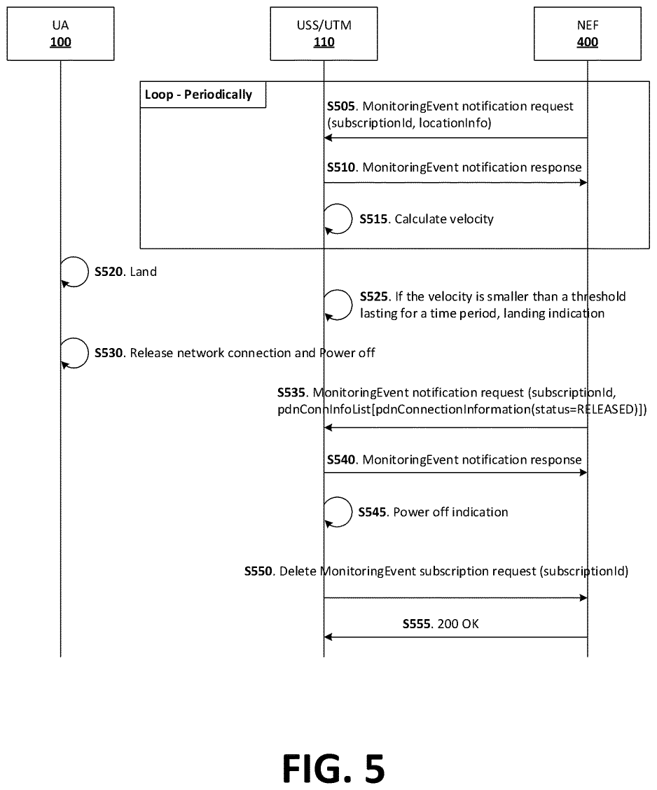

FIG. 5 is a diagram illustrating an exemplary procedure for monitoring UA landing according to an embodiment of the present disclosure. As shown in FIG. 5, a USS/UTM (e.g., the USS/UTM 110 shown in FIG. 3) may monitor whether a UA (e.g., the UA 100 shown in FIG. 3) has landed or not by means of an NEF 400, which is a network function provided by a core network (e.g., the EPC/5GC 210 shown in FIG. 3). Please note that the procedure shown in FIG. 5 may be performed after the procedure shown in FIG. 4. Therefore, some steps in FIG. 5 that are repeated from FIG. 4 are omitted for simplicity. For example, the steps S410 and S415 for subscribing a notification of UA power on event and the steps S440 and S445 for subscribing a periodical notification of UA location information are omitted from FIG. 5.

Referring to FIG. 5, the procedure may begin at step S505 where the NEF 400 may periodically send a “MonitoringEvent Notification” request to the USS/UTM 110. In some embodiments, the request may contain at least one of:
the subscriptionId (of the subscription of periodical location information); and
locationInfo indicating the network location of the UA 100.

However, the present disclosure is not limited thereto. In some other embodiments, the notification may contain different information for the same purpose.

At step S510, the USS/UTM 110 may send a “MonitoringEvent Notification” response back to the NEF 400.

At step S515, the USS/UTM 110 may calculate the velocity of the UA 100 based on the network location, or directly uses the ueVelocity attribute inside the locationInfo if available. For example, the step S515 may be substantially similar to the step S460 shown in FIG. 4.

At step S520, the UA 100 may land.

At step S525, if the velocity of the UA 100 is lower than a pre-defined threshold and last for a time period, the USS/UTM 110 may detect that the UA 100 has landed. After that, the USS/UTM 110 may further detect whether the UA 100 has been powered off or not. However, the present disclosure is not limited thereto. In some embodiments, the detection of whether the UA 100 has been powered off or not does not depend on the detection of whether the UA 100 has landed or not. In other words, the steps S505 through S525 may be omitted.

At step S530, the UA 100 may release a network connection and be powered off.

At step S535, the NEF 400 may send a “MonitoringEventNotification” request to the USS/UTM 110. In some embodiments, the request may contain at least one of:
the subscriptionId (of the subscription of PDN network connectivity); and
pdnConnInfoList that includes the information of one or more PDN connections, where the information of the target PDN connection contains a “status” attribute set to “RELEASED”.

At step S540, the USS/UTM 110 may send a “MonitoringEvent Notification” response back to the NEF 400.

At step S545, the USS/UTM 110 may detect that the UA 100 is power-off.

At step S550, the USS/UTM 110 may send a “Delete MonitoringEvent Subscription” request back to the NEF 400 to delete the previous location monitoring.

At step S555, the NEF 400 may send a successful response back to the USS/UTM 110.

Therefore, with this procedure, the USS/UTM 110 may detect whether the UA 100 has landed and/or whether the UA 100 has been powered off.

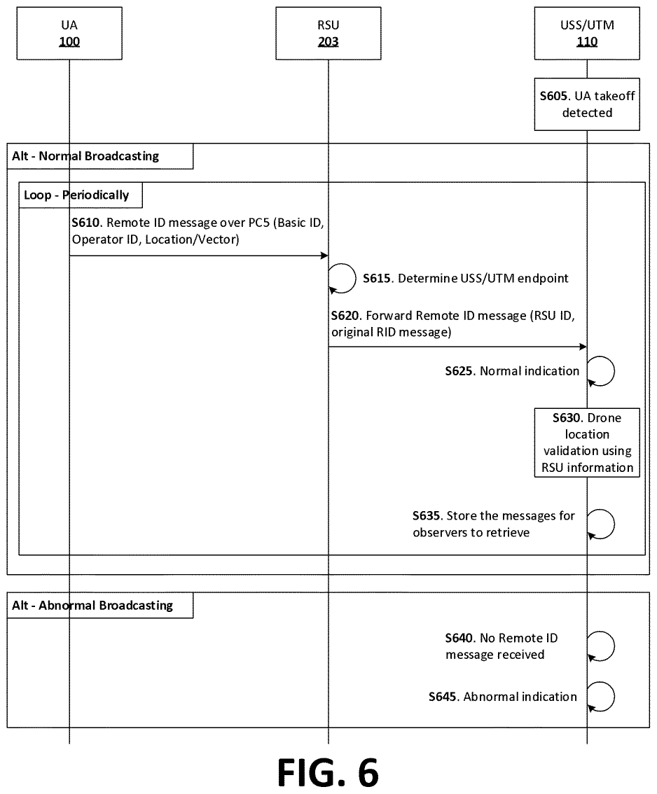

FIG. 6 is a diagram illustrating an exemplary procedure for monitoring RID broadcasting using RSUs according to an embodiment of the present disclosure. As shown in FIG. 6, a USS/UTM (e.g., the USS/UTM 110 shown in FIG. 3) may monitor whether a UA (e.g., the UA 100 shown in FIG. 3) is broadcasting its RID information or not by means of one or more RSUs (e.g., the RSUs 203 shown in FIG. 3).

Referring to FIG. 6, the procedure may begin at step S605 where the USS/UTM 110 may detect that the UA 100 has taken off. In some embodiments, this detection may be achieved by the procedure shown in FIG. 4. However, the present disclosure is not limited thereto. Further, this step is not mandatory, and therefore in some other embodiments it can be omitted.

At step S610, if the UA 100 periodically broadcasts the RID message over PC5, the RID message may be received by the RSU 203. In some embodiments, the RID message may contain at least one of:
BasicID carries the UAS ID,
OperatorID which is the unique identification of the UA operator and,
Location/Vector provides the UA location, altitude, heading, speed, and status.

However, the present disclosure is not limited thereto. In some other embodiments, the RID message may contain different information for the same purpose.

At step S615, the RSU 203 may determine the USS/UTM endpoint (e.g., the USS/UTM 110) based on OperatorID or local configurations.

At step S620, when the RSU 203 receives the RID messages, it may forward them to the corresponding USS/UTM 110 indicated by the OperatorID in the original RID messages.

At step S625, if the USS/UTM 110 periodically receives the forwarded RID messages originated from the UA 100, it may determine that the UA 100 is in normal status. In some embodiments, before the USS/UTM 110 can determine that the UA 100 is in normal status, the USS/UTM 110 may verify that the broadcasted RID messages were sent by the claimed sender and/or that the sender is in the claimed DRIP Identity Management Entity (DIME) as required by GEN-2.

At step S630, the USS/UTM 110 may use the RSU information to validate the location information inside the RID messages, which will be described in detail with reference to FIG. 7A and FIG. 7B.

At step S635, the USS/UTM 110 may store the RID messages to support observers to retrieve the UA information via an internet connection, which is so-called Network Remote ID. In other words, although the UA 100 may only support Broadcast Remote ID, with the help of RSUs 203, the Network Remote ID can also be achieved.

At step S640, if the USS/UTM 110 does not periodically receive the forwarded RID messages originated from the UA 100, it may determine that the UA 100 is in abnormal status at step S645.

Therefore, with this procedure, the USS/UTM 110 may monitor the RID broadcasting for the UA 100 via one or more RSU 203.

FIG. 7A and FIG. 7B are diagrams illustrating exemplary methods for determining whether a reported location is trusted or not according to an embodiment of the present disclosure. As shown in FIG. 7A, each of the RSUs (e.g., the RSUs 203-1 and 203-2 shown in FIG. 7A and FIG. 7B) has a listening area as indicated by the dotted circle, and the overlapped part of the listening areas may be named as “Receiving Area”. In such a case, if the two RSUs 203-1 and 203-2 receive a same RID message, which claims that the UA 100 is located at a claimed location indicated by the dark solid circle, then the USS/UTM 110 may determine whether the claimed location is in the receiving area of the two RSUs 203-1 and 203-2.

In some embodiments, if the location claimed by the UA 100 is inside the Receiving Area, the USS/UTM 110 may determine that the claimed location inside the RID message is trusted, which is shown in FIG. 7A. On the other hand, if the location claimed by the UA 100 significantly deviates from the Receiving Area, the USS/UTM 110 may determine that the claimed location inside the RID message is untrusted, which is shown in FIG. 7B.

In some embodiments, an offset distance may be configured or pre-configured at the USS/UTM 110. In some embodiments, the USS/UTM 110 may determine that the claimed location is trusted if the claimed location is located inside and/or separated from the overlapped area by less than the offset distance. In some embodiments, the USS/UTM 110 may determine that the claimed location is untrusted if the claimed location is separated from the overlapped area by the offset distance or more.

With the embodiments described above, the network (e.g., USS/UTM 110) may monitor whether or not a drone broadcasts RID message during the flight. Further, with the embodiments described above, the network (e.g., USS/UTM 110) may validate the drone claimed locations by the information of receiving RSUs. Furthermore, with the embodiments described above, observers are enabled to query drone information through Internet connection (i.e., Broadcast Remote ID and Network Remote ID are converged).

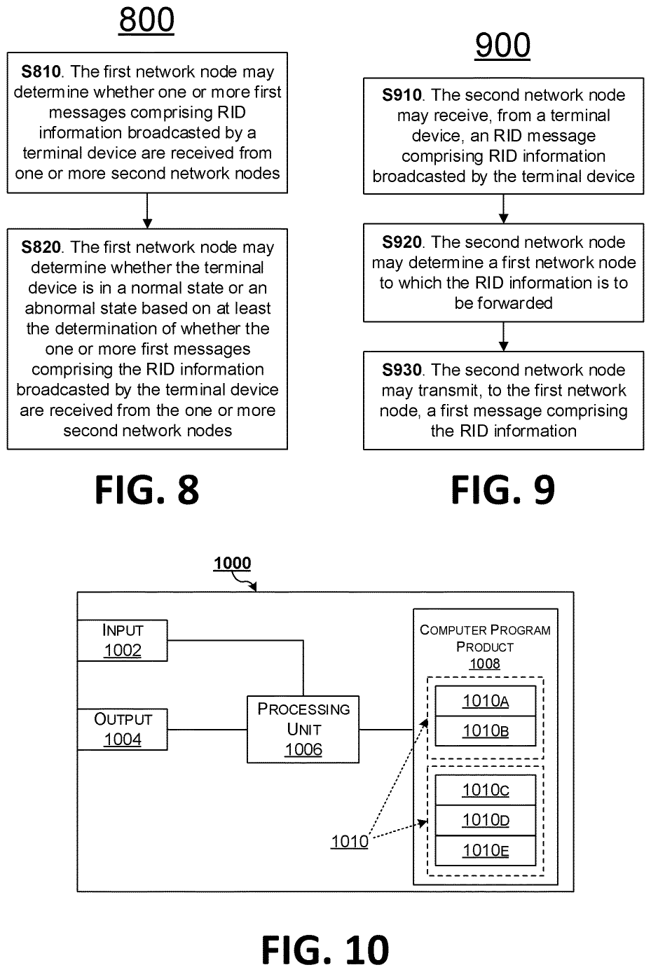

FIG. 8 is a flow chart of an exemplary method 800 at a first network node for RID according to an embodiment of the present disclosure. The method 800 may be performed at a network node (e.g., the USS/UTM 110 shown in FIG. 3). The method 800 may comprise steps S810 and S820. However, the present disclosure is not limited thereto. In some other embodiments, the method 800 may comprise more steps, less steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where the first network node may determine whether one or more first messages comprising RID information broadcasted by a terminal device are received from one or more second network nodes.

At step S820, the first network node may determine whether the terminal device is in a normal state or an abnormal state based on at least the determination of whether the one or more first messages comprising the RID information broadcasted by the terminal device are received from the one or more second network nodes.

In some embodiments, the step of determining whether the terminal device is in a normal state or an abnormal state may comprise at least one of: determining that the terminal device is in a normal state for a first time period in response to determining that at least one first message comprising the RID information broadcasted by the terminal device is received from at least one of the second network nodes during the first time period; and determining that the terminal device is in an abnormal state for a first time period in response to determining that no first message comprising the RID information broadcasted by the terminal device is received from the one or more second network nodes during the first time period.

In some embodiments, the RID information may indicate at least one of: an identifier associated with the terminal device; an identifier associated with an operator that is operating the terminal device; a location of the terminal device; an altitude of the terminal device; a heading of the terminal device; a speed of the terminal device; and a status of the terminal device. In some embodiments, the first message may further indicate an identifier of the second network node.

In some embodiments, the terminal device may be an unmanned aircraft, wherein before the step of determining whether one or more first messages comprising RID information broadcasted by a terminal device are received from one or more second network nodes, the method 800 may further comprise at least one of: determining whether the terminal device has taken off or not; and determining whether the terminal device has landed or not. In some embodiments, before the step of determining whether the terminal device has taken off or not and/or the step of determining whether the terminal device has landed or not, the method 800 may further comprise: transmitting, to a third network node, a second message for subscribing periodical notifications of location information for the terminal device; and receiving, from the third network node, a third message indicating an identifier associated with a first subscription of the periodical notifications of location information for the terminal device.

In some embodiments, the method 800 may further comprise: periodically receiving, from the third network node, fourth messages for notifying the first network node of the location information for the terminal device; and transmitting, to the third network node, fifth messages in response to the fourth messages, respectively. In some embodiments, the method 800 may further comprise at least one of: determining the velocity of the terminal device based on at least locations of the terminal device indicated by the location information in multiple fourth messages; and determining the velocity of the terminal device based on at least a velocity of the terminal device indicated by the location information in one or more fourth messages.

In some embodiments, the method 800 may further comprise: determining whether the velocity of the terminal device is higher than a first threshold for a second time period or not, wherein the step of determining whether the terminal device has taken off or not comprises at least one of: determining that the terminal device has taken off in response to determining that the velocity of the terminal device is higher than the first threshold for the second time period; and determining that the terminal device has not taken off in response to determining that the velocity of the terminal device is not higher than the first threshold for the second time period. In some embodiments, the method 800 may further comprise: determining whether the velocity of the terminal device is lower than a second threshold for a third time period or not, wherein the step of determining whether the terminal device has landed or not comprises at least one of: determining that the terminal device has landed in response to determining that the velocity of the terminal device is lower than the second threshold for the third time period; and determining that the terminal device has not landed in response to determining that the velocity of the terminal device is not lower than the second threshold for the third time period.

In some embodiments, the second message may indicate at least one of: an identifier of the terminal device; an indicator indicating that a notification of location information is to be subscribed; and an indicator indicating a callback endpoint to receive the periodical notifications. In some embodiments, at least one of the fourth messages may indicate at least one of: the identifier associated with the first subscription; and the location information for the terminal device. In some embodiments, the method 800 may further comprise at least one of: determining whether the terminal device is powered on; and determining whether the terminal device is powered off. In some embodiments, before the step of determining whether the terminal device is powered on and/or the step of determining whether the terminal device is powered off, the method 800 may further comprise: transmitting, to the third network node, a sixth message for subscribing a notification of a network connectivity status for the terminal device; and receiving, from the third network node, a seventh message indicating a identifier association with a second subscription of the notification of the network connectivity status for the terminal device. In some embodiments, the method 800 may further comprise: receiving, from the third network node, an eighth message for notifying the first network node of the network connectivity status for the terminal device; and transmitting, to the third network node, a ninth message in response to the eighth message.

In some embodiments, the method 800 may further comprise at least one of: determining that the terminal device is powered on in response to receiving an eighth message indicating that a network connection is created for the terminal device; and determining that the terminal device is powered off in response to receiving an eighth message indicating that a network connection is released for the terminal device. In some embodiments, the sixth message may indicate at least one of: an identifier of the terminal device; an indicator indicating that a notification of a network connectivity status is to be subscribed; and an indicator indicating a callback endpoint to receive the notification. In some embodiments, the eighth message may indicate at least one of: the identifier associated with the second subscription; and information for a network connectivity status for a network connection associated with the terminal device.

In some embodiments, the method 800 may further comprise: transmitting, to the third network node, a tenth message for unsubscribing the periodical notifications of the location information for the terminal device; and receiving, from the third network node, an eleventh message in response to the ninth message. In some embodiments, when multiple first messages are received from multiple second network nodes, respectively, the method 800 may further comprise: determining whether the RID information comprised in the multiple first messages are same to each other; and determining whether a location of the terminal device indicated by the multiple first messages is in an overlapped area of the listening areas of the multiple second network nodes in response to determining that the RID information comprised in the multiple first messages are same to each other. In some embodiments, the method 800 may further comprise at least one of: determining that the location of the terminal device indicated by the multiple first messages is trusted in response to determining that the location of the terminal device indicated by the multiple first messages is in the overlapped area; and determining that the location of the terminal device indicated by the multiple first messages is untrusted in response to determining that the location of the terminal device indicated by the multiple first messages is separated from the overlapped area by an offset distance. In some embodiments, for at least one of the multiple second network nodes, its identifier and/or listening area may be preconfigured or configured at the first network node.

In some embodiments, the method 800 may further comprise: storing the RID information. In some embodiments, the method 800 may further comprise: receiving, from a fourth node, a twelfth message for requesting the RID information for the terminal device; and transmitting, to the fourth node, a thirteenth message indicating the stored RID information for the terminal device. In some embodiments, at least one of following may be true: the terminal device is an Unmanned Aircraft (UA); the first network node is an Unmanned Aircraft System (UAS) Service Supplier (USS) node and/or a UAS Traffic Management (UTM) node; the one or more second network nodes are Road Side Units (RSUs); the third network node is a Network Exposure Function (NEF) and/or a Service Capability Exposure Function (SCEF); and the fourth node is an observer's device. In some embodiments, the RID information may be broadcasted by the terminal device via Sidelink (SL) communication.

FIG. 9 is a flow chart of an exemplary method 900 at a second network node for facilitating a terminal device in RID according to an embodiment of the present disclosure. The method 900 may be performed at an RSU (e.g., the RSU 203 shown in FIG. 3). The method 900 may comprise steps S910, S920, and S930. However, the present disclosure is not limited thereto. In some other embodiments, the method 900 may comprise more steps, less steps, different steps, or any combination thereof.

Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910 where the second network node may receive, from the terminal device, an RID message comprising RID information broadcasted by the terminal device.

At step S920, the second network node may determine a first network node to which the RID information is to be forwarded.

At step S930, the second network node may transmit, to the first network node, a first message comprising the RID information.

In some embodiments, the RID information may indicate at least one of: an identifier associated with the terminal device; an identifier associated with an operator that is operating the terminal device; a location of the terminal device; an altitude of the terminal device; a heading of the terminal device; a speed of the terminal device; and a status of the terminal device. In some embodiments, the step of determining the first network node may comprise: determining the first network node based on at least an identifier associated with an operator that is operating the terminal device and/or one or more local configurations. In some embodiments, the first message may further indicate an identifier of the second network node.

In some embodiments, at least one of following may be true: the terminal device is a UA; the first network node is a USS node and/or a UTM node; and the second network node is an RSU. In some embodiments, the RID information may be broadcasted by the terminal device via SL communication.

FIG. 10 schematically shows an embodiment of an arrangement which may be used in network nodes according to an embodiment of the present disclosure.

Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000 and/or the network nodes in which it is comprised to perform the actions, e.g., of the procedure described earlier in conjunction with FIG. 4 through FIG. 9 or any other variant.

The computer program 1010 may be configured as a computer program code structured in computer program modules 1010A and 1010B. Hence, in an exemplifying embodiment when the arrangement 1000 is used in a first network node for RID, the code in the computer program of the arrangement 1000 includes: a module 1010A configured to determine whether one or more first messages comprising RID information broadcasted by a terminal device are received from one or more second network nodes; and a module 1010B configured to determine whether the terminal device is in a normal state or an abnormal state based on at least the determination of whether the one or more first messages comprising the RID information broadcasted by the terminal device are received from the one or more second network nodes.

Additionally or alternatively, the computer program 1010 may be further configured as a computer program code structured in computer program modules 1010C through 1010E. Hence, in an exemplifying embodiment when the arrangement 1000 is used in a second network node for facilitating a terminal device in RID, the code in the computer program of the arrangement 1000 includes: a module 1010C configured to receive, from the terminal device, an RID message comprising RID information broadcasted by the terminal device; a module 1010D configured to determine a first network node to which the RID information is to be forwarded; and a module 1010E configured to transmit, to the first network node, a first message comprising the RID information.

The computer program modules could essentially perform the actions of the flow illustrated in FIG. 4 through FIG. 9, to emulate the network nodes. In other words, when the different computer program modules are executed in the processing unit 1006, they may correspond to different modules in the network nodes.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network nodes.

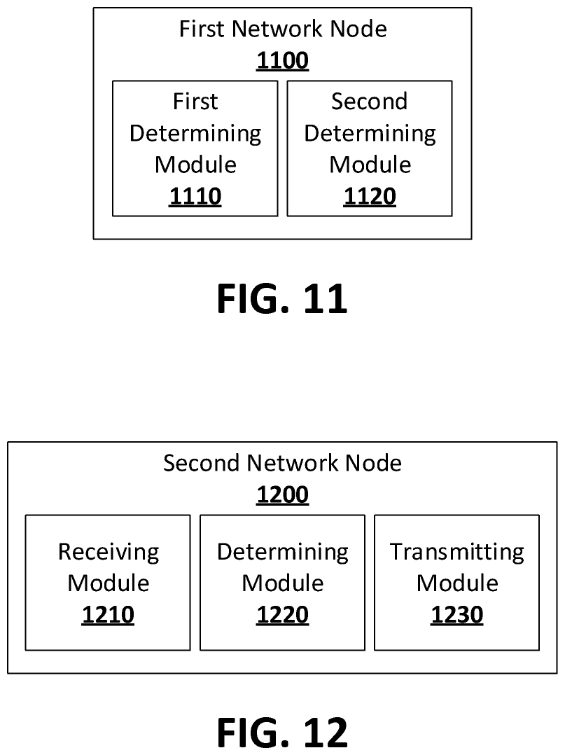

Correspondingly to the method 800 as described above, an exemplary first network node for RID is provided. FIG. 11 is a block diagram of an exemplary first network node 1100 according to an embodiment of the present disclosure. The first network node 1100 may be, e.g., the USS/UTM 110 in some embodiments.

The first network node 1100 may be configured to perform the method 800 as described above in connection with FIG. 8. As shown in FIG. 11, the first network node 1100 may comprise a first determining module 1110 configured to determine whether one or more first messages comprising RID information broadcasted by a terminal device are received from one or more second network nodes; and a second determining module 1120 configured to determine whether the terminal device is in a normal state or an abnormal state based on at least the determination of whether the one or more first messages comprising the RID information broadcasted by the terminal device are received from the one or more second network nodes.

The above modules 1110 and/or 1120 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the first network node 1100 may comprise one or more further modules, each of which may perform any of the steps of the method 800 described with reference to FIG. 8.

Correspondingly to the method 900 as described above, an exemplary second network node for facilitating a terminal device in RID is provided. FIG. 12 is a block diagram of an exemplary second network node 1200 according to an embodiment of the present disclosure. The second network node 1200 may be, e.g., the RSU 203 in some embodiments.

The second network node 1200 may be configured to perform the method 900 as described above in connection with FIG. 9. As shown in FIG. 12, the second network node 1200 may comprise a receiving module 1210 configured to receive, from the terminal device, an RID message comprising RID information broadcasted by the terminal device; a determining module 1220 configured to determine a first network node to which the RID information is to be forwarded; and a transmitting module 1230 configured to transmit, to the first network node, a first message comprising the RID information.

The above modules 1210, 1220, and/or 1230 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 9. Further, the second network node 1200 may comprise one or more further modules, each of which may perform any of the steps of the method 900 described with reference to FIG. 9.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BVLOS | Beyond Visual Line of Sight |
| C2 | Command and Control |
| GCS | Ground Control System |
| GNSS | Global Navigation Satellite System |
| NET-RID DP | Network Remote Identification |
| | Display Provider |
| NET-RID SP | Network Remote Identification |
| | Service Provider |
| RF | Radio Frequency |
| RID | Remote ID |
| RSU | Road-Side Unit |
| UA | Unmanned Aircraft |
| UAS | Unmanned Aircraft System |
| UAV | Unmanned Aerial Vehicle |
| USS | UAS Service Supplier |
| UTM | UAS Traffic Management |

1. A method at a first network node remote identification, the method comprising:
determining whether one or more first messages comprising RID information broadcasted by a terminal device are received from one or more second network nodes; and
determining whether the terminal device is in a normal state or an abnormal state based on at least the determination of whether the one or more first messages comprising the RID information broadcasted by the terminal device are received from the one or more second network nodes.

2. The method of claim 1, wherein
the step of determining whether the terminal device is in a normal state or an abnormal state comprises at least one of:
determining that the terminal device is in a normal state for a first time period in response to determining that at least one first message comprising the RID information broadcasted by the terminal device is received from at least one of the second network nodes during the first time period; and/or
determining that the terminal device is in an abnormal state for a first time period in response to determining that no first message comprising the RID information broadcasted by the terminal device is received from the one or more second network nodes during the first time period.

3. The method of claim 1, wherein
the RID information indicates:
an identifier associated with the terminal device;
an identifier associated with an operator that is operating the terminal device;
a location of the terminal device;
an altitude of the terminal device;
a heading of the terminal device;
a speed of the terminal device; and/or
a status of the terminal device.

4. The method of claim 1, wherein
the first message further indicates an identifier of the second network node.

5. The method of claim 1, wherein
the terminal device is an unmanned aircraft, and
before the step of determining whether one or more first messages comprising RID information broadcasted by a terminal device are received from one or more second network nodes, the method further comprises:
determining whether the terminal device has taken off or not; and/or
determining whether the terminal device has landed or not.

6. The method of claim 5, wherein
before the step of determining whether the terminal device has taken off or not and/or the step of determining whether the terminal device has landed or not, the method further comprises:
transmitting, to a third network node, a second message for subscribing periodical notifications of location information for the terminal device;
receiving, from the third network node, a third message indicating an identifier associated with a first subscription of the periodical notifications of location information for the terminal device;
periodically receiving, from the third network node, fourth messages for notifying the first network node of the location information for the terminal device; and
transmitting, to the third network node, fifth messages in response to the fourth messages, respectively.

7. (canceled)

8. The method of claim 6, wherein
the method further comprises:
determining the velocity of the terminal device based on at least locations of the terminal device indicated by the location information in multiple fourth messages; and/or
determining the velocity of the terminal device based on at least a velocity of the terminal device indicated by the location information in one or more fourth messages.

9. The method of claim 8, wherein
the method further comprises determining whether the velocity of the terminal device is higher than a first threshold for a second time period or not, and
the step of determining whether the terminal device has taken off or not comprises:
determining that the terminal device has taken off in response to determining that the velocity of the terminal device is higher than the first threshold for the second time period; and/or
determining that the terminal device has not taken off in response to determining that the velocity of the terminal device is not higher than the first threshold for the second time period.

10. The method of claim 8, wherein
the method further comprises determining whether the velocity of the terminal device is lower than a second threshold for a third time period or not, and
the step of determining whether the terminal device has landed or not comprises:
determining that the terminal device has landed in response to determining that the velocity of the terminal device is lower than the second threshold for the third time period; and/or
determining that the terminal device has not landed in response to determining that the velocity of the terminal device is not lower than the second threshold for the third time period.

11. The method of claim 6, wherein
the second message indicates:
an identifier of the terminal device;
an indicator indicating that a notification of location information is to be subscribed;
an indicator indicating a callback endpoint to receive the periodical notifications;
the identifier associated with the first subscription; and/or
the location information for the terminal device.

12. (canceled)

13. The method of claim 6, wherein
the method further comprises:
determining whether the terminal device is powered on; and/or
determining whether the terminal device is powered off, and
before the step of determining whether the terminal device is powered on and/or the step of determining whether the terminal device is powered off, the method further comprises:
transmitting, to the third network node, a sixth message for subscribing a notification of a network connectivity status for the terminal device; and
receiving, from the third network node, a seventh message indicating a identifier association with a second subscription of the notification of the network connectivity status for the terminal device.

14. (canceled)

15. The method of claim 13, wherein
the method further comprises
receiving, from the third network node, an eighth message for notifying the first network node of the network connectivity status for the terminal device;
transmitting, to the third network node, a ninth message in response to the eighth message, and
the method further comprises
determining that the terminal device is powered on in response to receiving an eighth message indicating that a network connection is created for the terminal device; and/or
determining that the terminal device is powered off in response to receiving an eighth message indicating that a network connection is released for the terminal device.

16. (canceled)

17. The method of claim 13, wherein
the sixth message indicates:
an identifier of the terminal device;
an indicator indicating that a notification of a network connectivity status is to be subscribed;
an indicator indicating a callback endpoint to receive the notification;
the identifier associated with the second subscription;
information for a network connectivity status for a network connection associated with the terminal device.

18. (canceled)

19. The method of claim 6, wherein
the method further comprises:
transmitting, to the third network node, a tenth message for unsubscribing the periodical notifications of the location information for the terminal device; and
receiving, from the third network node, an eleventh message in response to the ninth message.

20. The method of claim 1, wherein
when multiple first messages are received from multiple second network nodes, respectively, the method further comprises:
determining whether the RID information comprised in the multiple first messages are same to each other; and
determining whether a location of the terminal device indicated by the multiple first messages is in an overlapped area of the listening areas of the multiple second network nodes in response to determining that the RID information comprised in the multiple first messages are same to each other.

21. The method of claim 20, wherein
the method further comprises:
determining that the location of the terminal device indicated by the multiple first messages is trusted in response to determining that the location of the terminal device indicated by the multiple first messages is in the overlapped area; and/or
determining that the location of the terminal device indicated by the multiple first messages is untrusted in response to determining that the location of the terminal device indicated by the multiple first messages is separated from the overlapped area by an offset distance.

22. (canceled)

23. The method of claim 1, wherein
the method further comprises:
storing the RID information;
receiving, from a fourth node, a twelfth message for requesting the RID information for the terminal device; and
transmitting, to the fourth node, a thirteenth message indicating the stored RID information for the terminal device.

24. (canceled)

25. The method of claim 1, wherein
at least one of following is true:
the terminal device is an Unmanned Aircraft (UA);
the first network node is an Unmanned Aircraft System (UAS) Service Supplier (USS) node and/or a UAS Traffic Management (UTM) node;
the one or more second network nodes are Road Side Units (RSUs);
the third network node is a Network Exposure Function (NEF) and/or a Service Capability Exposure Function (SCEF); and
the fourth node is an observer's device.

26. The method of claim 1, wherein
the RID information is broadcasted by the terminal device via Sidelink (SL) communication.

27. A first network node, comprising:
a processor;
a memory storing instructions which, when executed by the processor, cause the first network node to:
determine whether one or more first messages comprising remote identification (RID) information broadcasted by a terminal device are received from one or more second network nodes; and
determine whether the terminal device is in a normal state or an abnormal state based on at least the determination of whether the one or more first messages comprising the RID information broadcasted by the terminal device are received from the one or more second network nodes.

28-47. (canceled)
